(19) United States
(12) Patent Application Publication
(10) Pub. No.: US 2010/0215179 A1
(43) Pub. Date: Aug. 26, 2010

(54) Security Key Method In Semiconductor Manufacturing

(75) Inventors: Julie Atwood, Allen, TX (US); Vijay Bhalla, Allen, TX (US); Frances Crossno, Plano, TX (US); Christopher H. Fowler, Allen, TX (US); Meimei DiGennaro, Dallas, TX (US); Ty Greneaux, Lafayette, LA (US); Georges Jamieson, Dallas, TX (US); Jeanne Rickert, Richardson, TX (US); Edward J. Russell, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/669,001

(22) Filed: Jan. 30, 2007

Related U.S. Application Data
(60) Provisional application No. 60/763,795, filed on Jan. 31, 2006.

(51) Int. Cl. H04L 9/08

(52) U.S. Cl. 380/278

(57) ABSTRACT

The management of customer security keys by an integrated circuit manufacturer with automated material tracking among multiple circuit testers at multiple sites for programming keys into circuits. Limited key change methods plus sufficient key statuses provides processes for key handling.

### CROSS-REFERENCE TO RELATED APPLICATIONS

The application claims priority from provisional patent application No. 60/763,795, filed Jan. 31, 2006. The following copending, co-assigned patent application discloses related subject matter: application Ser. No. 10/935,811, filed Sep. 07, 2004.

### BACKGROUND OF THE INVENTION

The present invention relates to integrated circuit manufacturing, and more particularly to handling of security keys incorporated into devices.

Wireless communication systems allow portable electronic devices to locally interact. However, to be distinguishable among multiple devices capable of receiving a transmission, each device typically has a unique identification number hardwired into its transceiver integrated circuits. Thus as part of the manufacturing process, an inventory of identification numbers (e.g., Bluetooth IDs) must be programmed into the integrated circuits. Analogously, other systems require unique identification numbers such as integrated circuits with high-definition content protection (HDCP). Manufacturers typically program these identification numbers at the time of circuit testing (wafer probe or package test) and the programming involves electrically blowing fuses within the circuit or programming an EEPROM. Thus identification numbers should be readily available at any of possibly multiple testing sites with multiple testers at each site.

Additionally, an integrated circuit manufacturer's various customers (device vendors) may want their integrated circuits programmed with customer security keys such as a root public key for authentication, a random key for binding and secure storage, and a customer key for OEM-specific use. Such circuits would also contain hardware accelerators for cryptosystems such as DES or AES plus hash functions such as SHA-1. Security keys are delivered by a customer to its manufacturer for incorporation into devices during manufacturing. Typically, the non-public keys are encrypted for secure storage and need to be decrypted at time of programming into devices.

A public key cryptosystem uses separate-but-related encryption and decryption keys: a public key and a private key. The public key is used to encrypt messages which can be decrypted using the private key; thus no transmission of a key is needed. Public key cryptosystems also provide digital signatures on documents: the public key is used to decrypt (a hash of) a document which has been encrypted (signifying a signature) using the private key of the signer; the decrypted hash is compared to (a hash of) the presumed document to verify signature plus assure document identity. Of course, the “document” could be a symmetric key for an encrypted communication session using a cryptosystem such as DES or AES.

Expert recommendations suggest a root public key used for authentication should have 2048 bits; thus to save memory, an integrated circuit may only be programmed with a 128-bit hash of the public key. In contrast, other keys typically are much smaller, such as 64-128 bits.

A single integrated circuit manufacturer with multiple testing sites and, possibly, with affiliated foundry manufacturers for the same products will thus have a problem of management and distribution for integrated circuit programming of unique identification numbers and customer keys required by multiple customers. Further, management of security keys has problems such as tracking key status and responding to key security compromise due to external or internal events.

### SUMMARY OF THE INVENTION

The present invention provides an integrated circuit manufacturing system which includes management of customer security keys for programming into devices with prescribed key change methods, tracking key statuses, and providing event response processes which depend upon key status and key change method.

### BRIEF DESCRIPTION OF THE DRAWINGS

FIG. 1 is a flow diagram.

FIG. 2 shows key status change evolution.

FIG. 3 shows a system implementation.

### DESCRIPTION OF THE PREFERRED EMBODIMENTS

### 1. Overview

Preferred embodiment methods provide for an integrated circuit manufacturer to manage (e.g., receive, distribute, status track, event respond, etc.) sets of security keys provided by a customer and which are to be programmed into circuits as a part of circuit testing; the programming could be through blowing electrical fuses (or anti-fuses) by an automated circuit tester. A manufacturing system control contains information for each lot (e.g., 24 wafers or group of assembled units undergoing test) including customer security key handling parameters. Control processes provide for key receipt, storage and retrieval for usage plus handling special conditions that may occur during the life of a customer engagement, including security compromises and obsolescence of sets of keys.

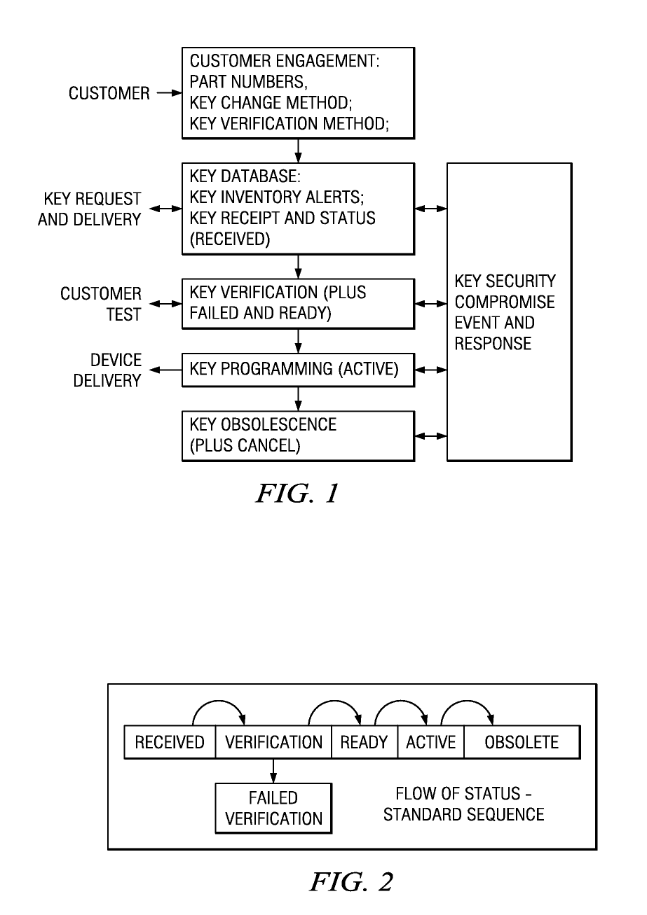

FIG. 1 illustrates method steps including customer engagement, key delivery, tracking a status for a set of keys corresponding to a manufacturing lot, and acceptable key usage, responses to key compromise events, key obsolescence events, and errors and alerts. Note that a customer key can be a public key (manufacturer's public key: MPK) or a secure key and delivered/stored in encrypted form (customer encrypted key: CEK).

FIG. 2 shows a typical status life cycle for a set of keys with status corresponding to steps in FIG. 1.

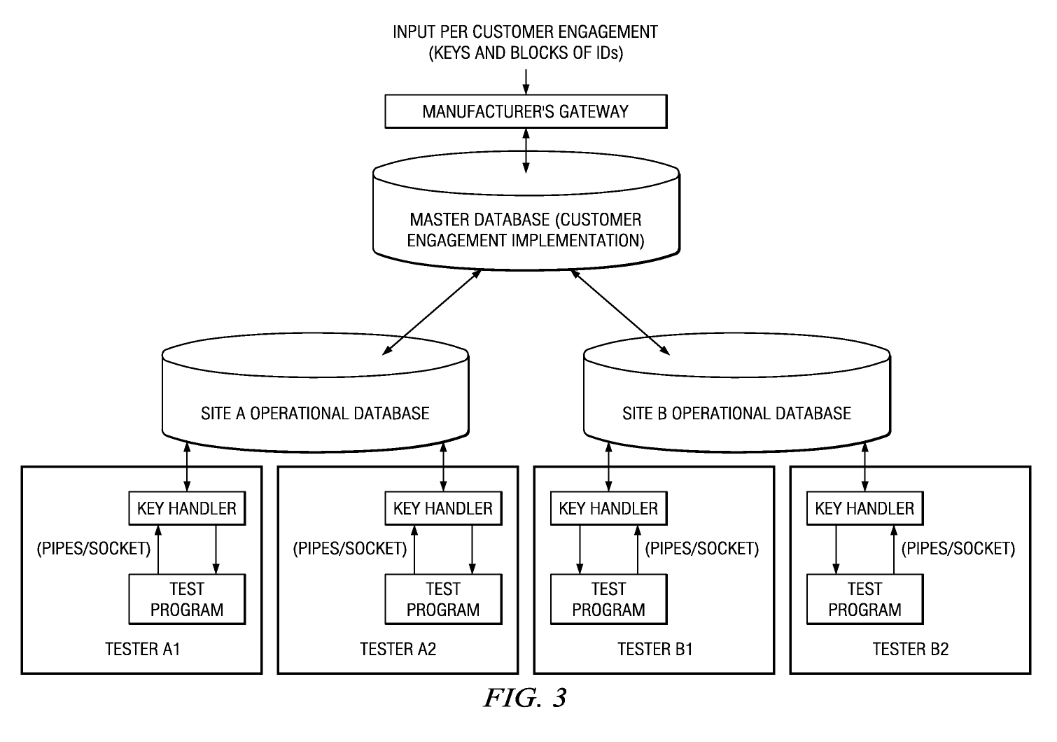

Further, FIG. 3 illustrates a simple manufacturing system of two sites with two automated testers at each site with each tester running various test software (e.g., tester automation and data collection tools); the testers blow electrical fuses to program a circuit.

The following sections provide descriptions of: Key change methods available; Data fields of information for keys; Key status and life cycle provisions; Errors and alert responses available; Key compromise responses available; Key obsolescence methods; and Key distribution methods.

### 2. Key Change Methods

Preferred embodiment security key management methods constrain key change to the following two change methods; this eliminates problems of other methods of key change such as change by number of units:

(a) Customer Part Number (CPN) Key Change Method

For each new set of keys, define a distinct product part number (once fused, parts are custom). Thus, a new set of keys will be established for different OEM products and/or wireless operators (based on distinct customer part number). This has advantages including:

Reduces potential integrity attack to specific customer/product

Once fused, parts are custom

Keys are identified by the Customer Part Number

Sample verification with each new key possible

(b) Lot-Level Based Key Change Method

New keys are changed and programmed for each manufacturing lot (e.g., 24 wafers or group of assembled units undergoing test). This has advantages including:

Reduces potential integrity attack to controlled quantity of product

Once fused, parts are custom

However, lot-based key change cannot be used for speed sort or multi-factory flow devices, and lot-based change requires a unique key identifier file (KIF) to track which keys are programmed into which units. This identifier can also be tied to a customer identifier which allows customers to track by their own number in their systems. Lot-based key change also requires an automated verification of keys prior to programming into units.

### 3. Fields for Parameters

Preferred embodiment management methods utilize the following fields (and referenced processes) associated with a manufacturing lot in the manufacturing system control. The values of the fields derive from the customer engagement.

(a) Customer Number (CN)

This is a Customer number created to represent to a Customer. This field along with Customer Part Number will be used to validate data sent from the Customer. If the data in the transmission does not match the Engagement table data, the transmitted data will be rejected.

(b) Customer Part Number

The Customer Part Number is used to specify which device will need to use a security key(s). This name should be used when purchasing product. Depending on the Key Change Method (see section 4 below), the Customer Part Number may change when a new set of security keys are used. This field along with the Customer Number will be used to validate data sent from the Customer. If the data in the transmission does not match the Engagement table data, the transmitted data will be rejected.

(c) Key Change Method

This field will be used to indicate the method of determining when security keys change. Two methods exist as described in foregoing section 2.

(1) CPN-based: This method specifies for a given Customer Part Number one set of security key(s) to be used to manufacture the device. If a new security key is desired, a new Customer Part Number must be identified.

(2) LOT-based: This method specifies for each Assembly/Test Lot a new set of security key(s) will be used. The Customer part number remains constant. If the Lot method is requested, a cross reference identifier known as a KIF (key information field) will be assigned to each set of security keys, symbolized on the units and included on the Customer Label.

If the Key Change Method in the Customer Transmittal data does not match the Key Change Method in the Customer Engagement Table, the entire record will be rejected and not setup in the Fuse table.

(d) KIF Required on Symbol

This field is used to identify whether or not the KIF value will be symbolized on the packaged device. This field may only be set to “Yes” if the Key Change Method is “Lot”. If “Yes”, the KIF value will be symbolized on the device during the manufacturing process. If “No”, the KIF value will not be symbolized on the device. If a KIF is symbolized on a device, then the Customer Label will also contain the KIF value.

If this field is “Yes”, then the following items will happen during the fuse process
i. A KIF is generated and assigned to a set of keys and to a lot.
ii. The symbol diagram needs to include a position for the KIF value.

(e) Required Keys

This field will be used to specify this set of security keys the Customer requires to be programmed for a specific Customer Part Number. The Customer can select any of the following.
i. MPK—Only the MPK security key needs to be programmed for this Customer Part Number
ii. MPK;CEK—both MPK and CEK security keys need to be programmed for this Customer Part Number

For MPK the Customer Key Transmittal format involves two fields the Manufacturer Public Key Hash Low (MPK Low) and Manufacturer Public Key Hash High (MPK High). If the engagement table includes MPK as a required key, the following verifications are done. If any of the following verifications fail, the entire record will be rejected and not setup in the Fuse table.
i. The Manufacturer Public Key Hash Low (MPK Low) must have a length of 66 characters, comprised of 64 character binary value with a leading 0b.
ii. The Manufacturer Public Key Hash High (MPK High) must have a length of 66 characters, comprised of 64 character binary value with a leading 0b.
iii. Both the Manufacturer Public Key Hash Low (MPK Low) and the Manufacturer Public Key Hash High (MPK High) must pass the above verifications steps before the data will be loaded to the Fuse database.

For CEK the Customer Key Transmittal format involves the Customer Encryption Key (CEK) field. If the engagement table includes CEK as a required key, the following verification is done. If the verification fails, the entire record will be rejected and not setup in the Fuse table.
i. The Customer Encryption Key (CEK) must have a length of 66 characters, comprised of 64 character binary value with a leading 0b.
ii. When updating the Fuse database, the Secure Flag is set to “Y” for CEK keys.

(f) Key Verification Type

This field with contain a value of “Sample” or “Object” or “None”. If “Sample” is selected, physical units must be programmed with the security keys and be shipped to the Customer. The Customer must verify the security feature works and send a response to manufacturer. If the verification is successful, this set of security keys will be made available to manufacturing. If the verification is unsuccessful, this set of security keys will be marked as obsolete and cannot be used in manufacturing. In the unsuccessful case, the customer will need to submit a new set of keys and the verification process will be repeated using the new set of keys.

If “Object” is selected the Customer Key Transmittal data must contain values in the Key Test Object and Key Test Object Type fields. Prior to allowing this record to be added to the Fuse database, the Object program will be executed and the security key set will be verified.

If “None” is selected, no additional verification of security keys is needed. The keys will be treated as ready for use in manufacturing.

If the Key Change Method is LOT Based, only “Object” or “None” may be selected for the Key Verification Type. If the Key Change Method is CPN any of “Sample” or “Object” or “None” may be selected for the Key Verification Type.

(g) Rolling KIF

This field is used to identify whether the Customer will allow units with multiple manufacturing lots containing different security keys to be packaged in the same reel, tray or bag. Multiple manufacturing lots containing different security keys on the same reel may also be referred to as multiple KIFs on one reel.

If “Yes” is selected, the Customer will allow two different KIFs to be included on one reel, tray or bag. Yes is the only option supported at this time. The No options is for future expansion.

If “No” is selected, then packages such as reel, tray and bags may only contain manufacturing lots with the same set of security keys. “No” does not mean an entire KIF will be shipped complete, it just means that only one KIF can be included on one reel, tray or bag.

(h) Low Key Alert Threshold

This field is used to identify when to send a notification within the manufacturer that manufacturer is running low on security keys for a specific engagement. If the number of keys in Ready status fall below the value entered in the Low Key Alert Threshold field an alert message will be sent.

(i) CPN Minimum Key Change Period

This field is used to identify the agreed minimum time, between manufacturer and the Customer, in months, that a specific Customer Number/Customer Part Number set of keys should be in an “Active” status. This time does not drive a key obsolescence time period. The key may be active for a longer time period than what is recorded in this field.

(j) CPN Alert Period

This field is used to identify when to send a notification, within manufacturer, to request new keys to be sent in for the next CPN based material. Once a set of keys have gone active, the planned end of key period is identified as the number of months listed in the CPN Minimum Key Change Period field from the initial active date. If the CPN Minimum Key change Period is 6 months, and the keys when active on January 1, the end of key period would be July 1. The CPN Alert Period is the number of months prior to the end of key period, which daily alert messages will be sent to the Error Notification e-mail Address recipient. In the example above if the CPN Alert Period was 3 months, the alert message would be sent beginning March 1.

(k) Receive Alert Message

For the Lot-based alerts, once the number of keys is above the minimum specified in the low Key Alert Threshold, the Lot-based alerts will automatically stop. If it is desired to stop receiving these alert messages prior to receiving the minimum number of keys, the Receive Alert Message may be set to No. The default setting for this field is Yes.

For the CPN based alerts, once the CPN alert messaging begins, the message will continue to be sent until either the trigger for the alert is changed or the Receive Alert Message field is set to No. Increasing the CPN Minimum Key Change Period and or decreasing the CPN Alert Period will result in recalculating the trigger which initiates the alert messaging. Changing the Receive Alert Message field to No states that no further alert messaging is needed for this engagement.

(l) Error Notification to Internal E-Mail Address

This field contains a broadcast message address(s) which will be used to publish errors identified during the business rule validation process. The same address(es) may be listed on multiple Customer Number/Customer Part Number entries. Email addresses must be restricted to internal manufacturer email addresses.

(m) Customer Submitting Security Keys

In some cases one Customer may identify another Customer to submit their security keys. By security keys, this means all information in the Customer Transmittal document. For example Customer A may allow Customer B to submit their security key data. To support this, in the Customer Engagement table, the Customer number field would contain the Customer Number for Customer A, and the Customer Submitting Security Keys would contain the Customer Number for Customer B. If left blank, the Customer Submitting Security Keys field will be assigned the value in the Customer Number field.

(n) Test Routine

This field is only used when the Key Verification Type is “Object”. To complete the Object verification three items are needed, a simulation of the hardware/chip, the Object program from the Customer, and a Test Routine supplied by Engineering. Since different products have different Test Routines, available Test Routines are predetermined, and selections made from the list.

With regard to key retrieval determination—how to insure the correct keys are retrieved for programming during testing—set up a cross reference table with supporting business process rules to be able to associate the correct Manufacturing ID (e.g., lot) with the correct set of keys received to be used for programming.

### 4. Status Values for a Set of Keys

FIG. 2 illustrates the standard progression (life cycle) of Status values for a set of keys: Received to Verification to Ready to Active to Obsolete. Key life cycle/retrieval/usage is controlled based on a series of Key statuses and business/system rules on conditions of key status changes. The Fuse Security Key database maintains the status information. The following is a complete list of statuses with descriptions;

(a) Received: A set of security keys have been received by manufacturer from customer. Multiple sets of security keys may exist in the Received status at one time.

(b) Verification: A verification of a set of transmitted security keys is in progress. Verifications may be done different ways depending on the selected Key Change Method. The tables below show the available Key Verification Types by Key Change Method. Multiple sets of security keys may exist in the Verification status at one time The Key Verification Types are:
i. Sample verification: The Customer has requested a few physical units to be produced with the security keys. These units are shipped to the Customer. Upon receipt the customer will evaluate the units determining whether the security keys are correct.
ii. Object verification: The Customer has requested a verification program to be run by manufacturer against the security keys. Once manufacturer has verified the program completed successfully, the test results with test data will be sent to the Customer. The Customer will have final say as to whether the test completed successfully.
iii. No verification: Once the security keys are successfully received by manufacturer, no additional checks are needed to verify the security keys

(c) Ready: The Key Verification process is complete. It is now ok to use this set of security keys in manufacturing. Multiple sets of security keys may exist in the Ready status at one time. If multiple keys are in a Ready status, the key with the earliest business-to-business (B2B) received Date/Time will be used first.

(d) Active: Manufacturing (e.g., a tester) has acquired or started using a set of security keys.

For the CPN-Based Key Change Method, only one set of security keys may be active at any given time for a particular CN/CPN.

For the Lot-Based Key Change Method, multiple sets of security keys may be active at any given time for a particular CN/CPN. Each set of keys will be associated with a one and only one manufacturing lot.

(e) Obsolete: The purpose of this status is to identify when the CEK can be removed from the fuse Key table or when the Key can no longer be used.
CPN-based CEK keys will have the status manually changed to Obsolete. Changing the status to Obsolete will result in the CEK key being deleted from the database. Also, changing the status to Obsolete should occur after:
   All lots using these keys have moved through the fuse security test logpoint.
   The manufacturing control system has been set to not allow new orders for this material.
   The Customer will to convert to the new CPN material
   All forecasts have been changed to reference the new CPN material
If needed the keys can be retrieved from the B2B archive data.

(f) Failed Verification: The verification process did not successfully complete.

(g) Cancel: The security key set has never been used in manufacturing. No replacement key was submitted.
i. Statuses which can be changed to Cancel include: Received, Ready, Verification, and Overridden
ii. Statuses which cannot be changed to Cancel include: Cancel, Compromised, Failed Verification, Obsolete, and Active.

(h) Compromised: At any point in a fuse project a set of keys may have the status changed to Compromised. Either the Customer or manufacturer may have a status changed to Compromised. Different processes need to be followed depending on the current status of the keys identified as compromised. If a set of keys is not active in manufacturing, meaning the status is Received, Verification, or Ready, one process is followed. The other process must include handling stopping the manufacturing process and stopping Customer Shipments.

(i) Overridden: If a security key set has never been used in manufacturing, the status can be changed to Overridden. Overridden means the set of keys will never be used in manufacturing. This request replaces (overrides) one set of keys with a new set of keys. Regardless of the status of the keys being overridden, the new set of keys will be assigned to the initial status depending on the Key Verification Type and Key Change Method.
i. Status values which can be Overridden include: Received, Ready, Verification, and Failed Verification.
ii. Status values which cannot be Overridden include: Cancel, Compromised, Obsolete, Overridden and Active.

The preferred embodiment methods use this set of status values to track security key usage/progress through a fuse project life cycle. Indeed, as security keys are submitted to manufacturer, depending upon the Customer, it may be necessary to go through a verification process comparing the Customer transmitted key data against an engagement agreement for the project. The status field will also be used to support the Key Change Methods: either CPN-Based or Lot-Based.

The populations of keys in the various combinations of status and verification type for the CPN-based and LOT-based change methods are:

### CPN-Based Key Change Method

| Status/Key | | | |
|---|---|---|---|
| Verification Type | Sample Verification | Object Verification | No Verification |
| Received | fuse Key Population | NA | NA |
| Verification | Manual | Fuse Key Population | NA |
| | | or | |
| | | Verification Update | |
| Failed Verification | Manual | Verification Update | NA |
| | or | or | |
| | Customer key test | Customer key test | |
| | result acceptance | result acceptance | |
| Ready | Manual | Manual | Fuse Key Population |
| | or | or | |
| | Customer key test | Customer key test | |
| | result acceptance | result acceptance | |
| Active | TestWare “Allocate a | TestWare “Allocate a | TestWare “Allocate a |
| | Key” stored procedure | Key” stored procedure | Key” stored procedure |
| Obsolete | Manual | Manual | Manual |
| Cancel | Fuse Key Population | Fuse Key Population | Fuse Key Population |
| | or | Or | Or |
| | Manual | Manual | Manual |
| Overridden | Fuse Key Population | Fuse Key Population | Fuse Key Population |
| Compromised | Manual | Manual | Manual |

### Lot-Based Key Change Method

| Status/Key | | |
|---|---|---|
| Verification | | |
| Type | Object Verification | No Verification |
| Received | NA | NA |
| Verification | Fuse Key Population | NA |
| | or | |
| | Verification Update | |
| Failed | Verification Update | NA |
| Verification | (manufacturer failed) | |
| | or | |
| | Customer key test result | |
| | acceptance (Customer failed) | |
| Ready | Customer key test result | Fuse Key Population |
| | acceptance | |
| Active | TestWare “Allocate a Key” | TestWare |
| | stored procedure | “Allocate a Key” |
| | | stored procedure |
| Obsolete | Purge Routine | Purge Routine |
| Cancel | Fuse Key Population | Fuse Key Population |
| | or | or |
| | Manual | Manual |
| Overridden | Fuse Key Population | Fuse Key Population |
| Compromised | Manual | Manual |

The possible status transitions are:

| Current key | |
|---|---|
| status | Possible next key status |
| Received | Verification, Cancel, Overridden, Compromised |
| Verification | Failed Verification, Cancel, Overridden, |
| | Compromised, Ready |
| Failed Verification | Overridden, Compromised |
| Ready | Active, Overridden, Cancel, Compromised |
| Active | Obsolete, Compromised |
| Obsolete | Compromised |
| Cancel | no next key |
| Compromised | Overridden, if the prior key was Received, |
| | Verification, Failed Verification, or Ready |
| Overridden | no next key |

### 5. Errors and Alerts

Error reporting provides manufacturer and/or the customer a notification of situations occurring during key verification and key transmittal, and occurs at two different times:
When a business-to-business (B2B) Syntax Error occurs
When a business rule is violated during B2B validation

Alert reporting provides manufacturer with a method of knowing when new security keys are needed from the Customer, and occurs at two different times:
When the amount of security keys becomes low
When a security key approaches its expiration date

Situations where error reporting occurs include:
B2B Syntax Error
Business Rule Validation Error

Manufacturer will receive alerts reminding of the need for new security keys. Alert reporting is dependant on key change method (CPN-based key change or Lot-based key change). For CPN based alert is sent a certain number of days before the key becomes obsolete, and for LOT based alert is sent when key count is below a set minimum (which may be specified by the Customer Engagement Manager).

### Key Obsolescence Alert (CPN Based)

The lifecycle of a CPN based key is setup during the engagement setup process. An alert message will be sent x months (set during engagement setup) prior to the expected expiration of key period.

### Low Key Alert (Lot Based)

On the Customer Engagement table a minimum key setting will identify when to send an alert message stating that key inventories are below the minimum number of available security keys required (specified by the Customer Engagement Manager).
To determine the minimum number of keys, all keys in a status of Ready will be counted. If the number is below the minimum, a standard alert message will be sent.

### 6. Key Security Compromise

A key can be compromised both internally and externally to manufacturer. Internally, only a CEK can be compromised because an MPK is a public key. Externally, both the CEK and the MPK can be compromised. The preferred embodiment systems provide steps that can be used at both manufacturer and the customer whenever a key is compromised. These steps include actions available for a Customer Engagement Manager at manufacturer.

The process depends upon whether the key change method is CPN-based or LOT-based, whether the key was internally or externally compromised, and value of the key status when it was compromised.

If it is unsure whether or not a key was compromised internally or externally, manufacturer's IT security is notified. Security will then need to research the situation. There are no differences in process if the customer's private key that derived the MPK is compromised.

Compromise scenarios and preferred embodiment provided responses are as follows, with CPN-Based described first, then Lot-based.

### CPN-Based Key Change

Key has been externally compromised while in received, verification, failed verification, or ready status

| Step | Who | What |
|---|---|---|
| 1 | Customer | Informs manufacturer of which keys have |
| | | been compromised via email or phone call. |
| | | Manufacturer saves message in specified storage |
| | | location |
| 2 | Customer | Logs on to the Fuse Security Key web site and |
| | Engagement | changes the key status to compromised. |
| | Manager | |
| 3 | Customer | Notifies manufacturer Law that a key has been |
| | Engagement | compromised externally. manufacturer Law will |
| | Manager | then take appropriate action. |
| 4 | Customer | Contacts customer to send in new keys via the |
| | Engagement | override feature. |
| | Manager | |

Key has been externally compromised while in active status

| Step | Who | What |
|---|---|---|
| 1 | Customer | Informs manufacturer of which keys have been compromised |
| | | via email or phone call. |
| | | Manufacturer saves message in specified storage location |
| 2 | Customer | Logs on to the Fuse Security Key web site and changes the |
| | Engagement | key status to compromised. |
| | Manager | |
| 3 | Customer | Notifies manufacturer Law that a key has been compromised |
| | Engagement | externally. manufacturer Law will then take appropriate |
| | Manager | action. |
| 4 | Customer | Notifies the appropriate assembly/test Planner, PDC |
| | Engagement | representative and the Customer Account Manager to inform |
| | Manager | them of compromised key. |
| 5 | Customer | Determine which revisions have been manufactured and |
| | Engagement | which ones have not via Fuse Security Key reporting. Notify |
| | Manager | QA of compromised keys on manufactured parts so they can take |
| | | appropriate action. |
| 6 | Customer | Refers to the customer engagement agreement, or talks to |
| | Engagement | the customer to understand if there are any special actions |
| | Manager | that need to occur. |
| 7 | Customer | If customer would like to continue using the compromised |
| | Engagement | key, Customer Engagement Manager should enter a request |
| | Manager | the key status be changed to active. After status is changed |
| | | back to active, continue manufacturing with the same keys. |
| 8 | Customer | If customer decides to discontinue using the compromised |
| | Engagement | key, work with them to resolve current inventory, setup a |
| | Manager | new CPN engagement, and change all backlog to the new |
| | | CPN. |

Key has been externally compromised while in obsolete status

| Step | Who | What |
|---|---|---|
| 1 | Customer | Informs manufacturer of which keys have been compromised |
| | | via email or phone call. |
| | | Manufacturer saves message in specified storage location > |
| 2 | Customer | Logs on to the Fuse Security Key web site and changes the key |
| | Engagement | status to compromised. |
| | Manager | |
| 3 | Customer | Notifies manufacturer Law that a key has been compromised |
| | Engagement | externally. manufacturer Law will then take appropriate action. |
| | Manager | |
| 4 | Customer | Notifies the appropriate assembly/test Planner, PDC |
| | Engagement | representative, and the customer account manager to inform |
| | Manager | them of compromised key and work with Customer to decide |
| | | what to do with current inventory. |
| 5 | Customer | Refers to the customer engagement agreement, or talks to the |
| | Engagement | customer to understand if there are any special actions that need to |
| | Manager | occur. |

Key is externally compromised while in cancel or overridden status
No action is required here because the key has never been used in manufacturing
Key has been internally compromised while in received, verification, failed verification, or ready status

| Step | Who | What |
|---|---|---|
| 1 | Customer | Notifies the customer of which key(s) have bee |
| | Engagement | compromised via email or phone call. |
| | Manager | Manufacturer saves message in specified storage |
| | | location |
| 2 | Customer | Logs on to the Fuse Security Key web site and |
| | Engagement | changes the key status to compromised. |
| | Manager | |
| 3 | Customer | Notifies manufacturer Law and Worldwide and IT |
| | Engagement | security that a key has been |
| | Manager | compromised (CEK Only) |
| 4 | Customer | Contacts customer to send in new keys via the |
| | Engagement | override feature. |
| | Manager | |
| 5 | Security | Researches how and why a CEK was compromised |
| | | within manufacturer |

Key has been internally compromised while in active status

| Step | Who | What |
|---|---|---|
| 1 | Customer | Notifies the customer of which keys have be |
| | Engagement | compromised via email or phone call. |
| | Manager | Manufacturer saves message in specified storage location |
| 2 | Customer | Logs on to the Fuse Security Key web site and changes the |
| | Engagement | key status to compromised. |
| | Manager | |
| 3 | Customer | Notifies manufacturer Law and IT security that a key has |
| | Engagement | been compromised (CEK Only) |
| | Manager | |
| 4 | Customer | Notifies the appropriate assembly/test Planner, PDC |
| | Engagement | representative and the Customer Account Manager to inform them |
| | Manager | of compromised key. |
| 5 | Customer | Determine which revisions have been manufactured and |
| | Engagement | which ones have not via reporting. Notify QA of |
| | Manager | compromised keys on manufactured parts so they can take |
| | | appropriate action. |
| 6 | Customer | Refers to the customer engagement agreement, or talks to |
| | Engagement | the customer to understand if there are any special actions |
| | Manager | that need to occur. |
| 7 | Customer | If customer would like to continue using the compromised |
| | Engagement | key, Customer Engagement Manager should enter a status |
| | Manager | change request. After status is changed back to active, |
| | | continue manufacturing with the same keys. |
| 8 | Customer | If customer decides to discontinue using the compromised |
| | Engagement | key, work with them to resolve current inventory, setup a |
| | Manager | new CPN engagement, and change all backlog to the new |
| | | CPN. |
| 9 | Security | Researches how and why a CEK was compromised within |
| | | manufacturer |

Key has been internally compromised while in obsolete status

| Step | Who | What |
|---|---|---|
| 1 | Customer | Notifies the customer of which keys have been |
| | Engagement | compromised via email or phone call. |
| | Manager | Manufacturer saves message in specified storage location |
| 2 | Customer | Logs on to the Fuse Security Key web site and changes the |
| | Engagement | key status to compromised. |
| | Manager | |
| 3 | Customer | Notifies manufacturer Law and IT security that a key has |
| | Engagement | been compromised (CEK Only) |
| | Manager | |
| 4 | Customer | Notifies the appropriate assembly/test Planner, PDC |
| | Engagement | representative, and the customer account manager to inform |
| | Manager | them of compromised key and work with Customer to decide what |
| | | to do with current inventory. |
| 5 | Customer | Refers to the customer engagement agreement, or talks to |
| | Engagement | the customer to understand if there are any special actions |
| | Manager | that need to occur. |
| 6 | Security | Researches how and why a CEK was compromised within |
| | | manufacturer |

Key has been internally compromised while in cancel or overridden status

| Step | Who | What |
|---|---|---|
| 1 | Customer | Notifies IT security that a key has been |
| | Engagement | compromised (CEK Only) |
| | Manager | |
| 2 | Security | Researches how and why a CEK was compromised |
| | | within manufacturer |

### Lot Based

Key has been externally compromised while in received, verification, failed verification, or ready status

| Step | Who | What |
|---|---|---|
| 1 | Customer | Informs manufacturer of which keys have been |
| | | compromised via email or phone call, including |
| | | the CPN/KIF & revision number(s) - |
| | | (not key #, but revision #) Manufacturer |
| | | saves message in specified storage location |
| 2 | Customer | Logs on to the Fuse Security Key web site and |
| | Engagement | changes the key status to compromised. |
| | Manager | |
| 3 | Customer | Notifies manufacturer Law that a key has |
| | Engagement | been compromised externally. Manufacturer |
| | Manager | Law will then take appropriate action. |
| 4 | Customer | Contacts customer to send in new keys via the |
| | Engagement | override feature. |
| | Manager | |

Key has been externally compromised while in active status

| Step | Who | What |
|---|---|---|
| 1 | Customer | Informs manufacturer of which keys have been compromised via |
| | | email or phone call, including the CPN/KIF & revision |
| | | number(s) - (not key #, but revision #) |
| | | Manufacturer saves message in specified storage location |
| 2 | Customer | Logs on to the Fuse Security Key web site and changes the |
| | Engagement | key status to compromised. |
| | Manager | |
| 3 | Customer | Notifies manufacturer Law that a key has been compromised |
| | Engagement | externally. Manufacturer Law will then take appropriate |
| | Manager | action. |
| 4 | Customer | Notifies the appropriate assembly/test Planner, PDC |
| | Engagement | representative and the Customer Account Manager to inform them |
| | Manager | of compromised key. |
| 5 | Customer | Determines which revisions have been manufactured and |
| | Engagement | which ones have not via reporting. Notify QA of |
| | Manager | compromised keys on manufactured parts so they can take |
| | | appropriate action. |
| 6 | Customer | Refers to the customer engagement agreement, or talks to |
| | Engagement | the customer to understand if there are any special actions |
| | Manager | that need to occur. |
| 7 | Customer | If customer would like to continue using the compromised |
| | Engagement | key, Customer Engagement Manager should enter a request |
| | Manager | the key status be changed to active. After status is changed |
| | | back to active, continue manufacturing with the same keys. |
| 8 | Customer | If customer decides to discontinue using the compromised |
| | Engagement | key, work with them to see what we should do with current |
| | Manager | inventory, and get them to send in new keys if needed. |

Key has been externally compromised while in obsolete status

| Step | Who | What |
|---|---|---|
| 1 | Customer | Informs manufacturer of which keys have been compromised |
| | | via email or phone call, including the CPN/KIF & revision |
| | | number(s) - (not key #, but revision #) |
| | | Manufacturer saves message in specified storage location |
| 2 | Customer | Logs on to the Fuse Security Key web site and changes the |
| | Engagement | key status to compromised. |
| | Manager | |
| 3 | Customer | Notifies manufacturer Law that a key has been compromised |
| | Engagement | externally. Manufacturer Law will then take appropriate action. |
| | Manager | |
| 4 | Customer | Notifies the appropriate assembly/test Planner, PDC |
| | Engagement | representative, and the customer account manager to inform |
| | Manager | them of compromised key and work with Customer to decide what |
| | | to do with current inventory. |
| 5 | Customer | Refers to the customer engagement agreement, or talks to the |
| | Engagement | customer to understand if there are any special actions that |
| | Manager | need to occur. |

Key has been externally compromised while in cancel or overridden status
No action is required here because the key has never been used in manufacturing.
Key has been internally compromised while in received, verification, failed verification, or ready status

| Step | Who | What |
|---|---|---|
| 1 | Customer | Notifies the customer of which key(s) have been |
| | Engagement | compromised via email or phone call. |
| | Manager | Manufacturer saves message in specified |
| | | storage location |
| 2 | Customer | Logs on to the Fuse Security Key web site and |
| | Engagement | changes the key status to compromised. |
| | Manager | |
| 3 | Customer | Notifies manufacturer Law and IT security that |
| | Engagement | a key has been compromised (CEK Only) |
| | Manager | |
| 4 | Customer | Contacts customer to send in new keys via the |
| | Engagement | override feature. |
| | Manager | |
| 5 | Security | Researches how and why a CEK was compromised |
| | | within manufacturer |

Key has been internally compromised while in active status

| Step | Who | What |
|---|---|---|
| 1 | Customer | Notifies the customer of which key(s) have been |
| | Engagement | compromised via email or phone call. |
| | Manager | Manufacturer saves message in specified storage location |
| 2 | Customer | Logs on to the Fuse Security Key web site and changes |
| | Engagement | the key status to compromised. |
| | Manager | |
| 3 | Customer | Notifies manufacturer Law and IT security that a key has |
| | Engagement | been compromised (CEK Only) |
| | Manager | |
| 4 | Customer | Notifies the appropriate assembley/test Planner, PDC |
| | Engagement | representative and the Customer Account Manager to |
| | Manager | inform them of compromised key. |
| 5 | Customer | Determines which revisions have been manufactured and |
| | Engagement | which ones have not via reporting. Notify QA of |
| | Manager | compromised keys on manufactured parts so they can |
| | | take appropriate action. |
| 6 | Customer | Refers to the customer engagement agreement, or talks to |
| | Engagement | the customer to understand if there are any special actions |
| | Manager | that need to occur. |
| 7 | Customer | If customer would like to continue using the compromised |
| | Engagement | key, Customer Engagement Manager should enter a |
| | Manager | request the key status be changed to active. After status |
| | | is changed back to active, continue manufacturing with the same |
| | | keys. |
| 8 | Customer | If customer decides to discontinue using the compromised |
| | Engagement | key, work with them to see what we should do with current inventory, |
| | Manager | and get them to send in new keys if needed. |
| 9 | Security | Researches how and why a CEK was compromised within |
| | | manufacturer |

Key has been internally compromised while in obsolete status

| Step | Who | What |
|---|---|---|
| 1 | Customer | Notifies the customer of which key(s) have been |
| | Engagement | compromised via email or phone call. |
| | Manager | Manufacturer saves message in specified storage |
| | | location |
| 2 | Customer | Logs on to the Fuse Security Key web site |
| | Engagement | and changes the key status to compromised. |
| | Manager | |
| 3 | Customer | Notifies manufacturer Law and IT security that a |
| | Engagement | key has been compromised (CEK Only) |
| | Manager | |
| 4 | Customer | Notifies the appropriate assembly/test Planner, PDC |
| | Engagement | representative, and the customer account manager to |
| | Manager | inform them of compromised key and work with |
| | | Customer to decide what to do with current |
| | | inventory. |
| 5 | Customer | Refers to the customer engagement agreement, |
| | Engagement | or talks to the customer to understand if there are |
| | Manager | any special actions that need to occur. |
| 6 | Security | Researches how and why a CEK was compromised |
| | | within manufacturer. |

Key has been internally compromised while in cancel or overridden status

| Step | Who | What |
|---|---|---|
| 1 | Customer | Notifies IT security that a key has been |
| | Engagement | compromised (CEK Only) |
| | Manager | |
| 2 | Security | Researches how and why a CEK was compromised |
| | | within manufacturer |

### 7. Key Obsolescence Processes

The obsolescence of Fuse Security keys is dependant on key change method. The preferred embodiment systems provide for obsolescence methods as follows.

CPN Based keys will be obsoleted when the customer no longer wants to use the key/customer part number.

| Step | Who | What |
|---|---|---|
| 1 | Customer | Works with the customer to determine when to |
| | Engagement | obsolete a material |
| | Manager | |
| 2 | Customer | Ensures all WIP has completed the Fuse security |
| | Engagement | key process in the assembly/test. Once a key |
| | Manager | is deleted, no more units can be |
| | | manufactured with this key. |
| 3 | Customer | Logs on to the Fuse Security Key web site and |
| | Engagement | changes the key status to Obsolete. Changing |
| | Manager | the key to Obsolete results in the CEK being deleted |
| | | from the Fuse key database. |

Lot Based keys will automatically be set to obsolete in the Fuse key database 90 days after the key status became Active. No intervention by the Customer Engagement Manager is needed.

A key's status changes to Active when the lot is started in the Assembly/Test

90 days after a key goes active, the status will automatically change to Obsolete

### 8. Key and ID Distribution

Preferred embodiment method provides distribution of customer identifications and (encrypted) keys, for an integrated circuit manufacturer which makes multiple products for various customers and, additionally, has contracted some work out to one or more foundries. Each pertinent site has multiple (e.g., 100) automatic testers for electrically testing each circuit (still in wafer form or already packaged), and these testers are also capable of electrically blowing fuses in circuits under test to program various items, from IDs to activation of redundant circuitry, during the testing. The contract foundries would have similar setups. Each tester runs various software tools (e.g., tester automation and data collection) so its operator can set the tester to automatically test each circuit, to record test results, to program (i.e., blow fuses) IDs and keys for circuits which had tested as good, and so forth.

FIG. 3 illustrates a system where each tester at a site communicates with an operational database for the site. The tester downloads from the operational database blocks of IDs and/or sets of customer identifications or (decrypted) keys if circuits requiring these are under test. Conversely, the tester uploads to the operational database test results and requests for items being programmed into the circuits under test. A programmed set of customer keys may change with either the customer part number (CPN-based) or with each lot (for example, a lot of 24 wafers with 500 circuits per wafer may require a single set of customer keys but 12000 IDs). The tester downloads IDs in small blocks (e.g., blocks of 128).

The operational database for a site (including a foundry's site) acquires ID blocks and keys from a master database. And the master database contains large blocks of IDs and various (encrypted) customer keys as described in the foregoing.

The system of FIG. 3 operates as follows. An IC manufacturer acquires Customer Keys and blocks of IDs. A web interface is used by an engineer of the IC manufacturer to input IDs and Customer Keys to the master database. The master database is connected to the operational databases of the various testing sites (using local/wide area network or VPN) of the IC manufacturer (and any contract foundries) plus the manufacturer's IT systems which include entry points for the acquired IDs and/or customer keys.

Next, an operational database at a testing site pulls one block of IDs from the master database, and the corresponding entry in the master database inventory is updated as “allocated” to the operational database which requested it. This pulling of a block can be triggered by the inventory of available IDs at the operational database dropping to near-empty (low water mark). The operational database divides the block of IDs into smaller blocks. The site operational database is locally connected to the site testers, and the individual testers will pull a block of IDs from the operational database as needed. This hierarchical ID storage has the following benefits:

Reduces storage requirements.

Reduces load on the databases and network.

Further minimizes the chance that an ID will be used twice.

Allows histories of the used IDs to be kept for a longer time period. The distribution of Customer Keys, such as customer identification, encryption keys, and so forth can likewise be distributed with a master database, site operational databases, and the testers programming the information. The following section has implementation details for a typical system.

### 9. Distribution Implementation

a. Key Transmission and Management

Keys are transmitted from the customer electronically. Validation software checks information transmitted against what is required for the particular engagement type (CPN or LOT) as defined for the specific customer and customer part number engagement. There is also validation to prevent duplication of key revisions. Keys are stored in a centrally located Master Database. Customer encrypted keys are stored in the master database encrypted and are decrypted at the tester.

The business unit engineer or planner may use a web interface tool to manage the definition of the engagement as well as key status while ensuring the integrity of the keys. This tool does not allow viewing the value of encrypted keys.

b. Master and Operational Databases

Customer keys are automatically pulled from the master database (Fuse Security Key database) when requested; no push operation from the master database is required. If a new customer key is entered into the master database, it will be allocated to a local operational database when a tester requests it.

Blocks of IDs are pulled from the master database by operational databases, which partition the blocks into smaller blocks for the testers. A stored procedure on the operational database is used by the key handler (from a tester, see below) to grab the starting address of a block of IDs. This stored procedure updates the table containing available IDs. It will also update a history table to show which testers are being allocated the IDs. A table-level lock is made when a block is requested, guaranteeing that multiple key handlers hitting the same table will not get a duplicate block of IDs.

Tables for the master database and the Fuse Security Key database include a table for authorized users, a table for available and allocated IDs and a table for current customer keys and status.

The tables for the operational database include a table for available IDs, a table for allocated IDs and a table for current customer keys. A stored procedure allows the key handler task to easily pull one block of IDs; the procedure will take care of locking the “available” table, getting the next ID, and then it to the “allocated” table.

c. Key Handler

Key handler is a daemon task running a tester. Key handler will not connect to the operational database or grab any IDs or customer keys until the first request by the test program. If a customer key is requested by the test program, the key handler will get it from the operational database, decrypt it, and then pass it back to the test program. Key handler connects and disconnects to the operational database as needed. It does not remain connected while in an idle state. The test program can request one or more keys or IDs, which key handler requests from the operational database and returns to test program. Key handler will pull one block of IDs from the operational database and keep it as cache. This way the test program can request one ID at a time without having the key handler hit the operational database every time.

### 10. Modifications

The described preferred embodiment methods of security key management in integrated circuit manufacturing could be modified in many ways, such as by supporting variable length keys (both MPK and CEK), supporting a suspected security key compromise which could pause for a short time pending imminent compromise investigation, etc.

1. A method of managing customer keys for integrated circuit manufacturing with programmed keys, comprising the steps of:
(a) providing customer information fields in a manufacturing system control including a customer part number and a key change method;
(b) providing a key status for a set of keys;
(c) providing a plurality of key security compromise responses, said responses dependent upon said key change method and said key status for a set of keys, wherein said key varies per customer order; and
(d) providing distribution of keys to manufacturing sites for programming.

2. The method of claim 1, wherein said key change method is selected from the group consisting of (i) customer-part-number-based key change and (ii) lot-based key change.

3. The method of claim 1, wherein said status is selected from the group consisting of (i) received, (ii) verification, (iii) ready, (vi) active, and (v) obsolete

4. The method of claim 1, further comprising:
(a) providing key inventory alerts for customer submission of additional keys.

5. The method of claim 1, further comprising:
(a) providing key verification selected from the group consisting of (i) sample testing by customer, (ii) simulation test by manufacturer, and (iii) none.
